(19) United States
(12) Patent Application Publication
(10) Pub. No.: US 2026/0259057 A1
(43) Pub. Date: Sep. 3, 2026

(54) VEHICLE ROUTE PLANNING DEVICE, VEHICLE ROUTE PLANNING METHOD, AND VEHICLE ROUTE PLANNING SYSTEM

(71) Applicant: Nissan Motor Co., Ltd, Kanagawa (JP)

(72) Inventors: Yoshitaka Takagi, Kanagawa (JP); Yutaka Mikuriya, Kanagawa (JP)

(73) Assignee: Nissan Motor Co., Ltd, Kanagawa (JP)

(21) Appl. No.: 18/863,241

(22) PCT Filed: Mar. 13, 2023
(86) PCT No.: PCT/IB2023/000125

§ 371 Date: Nov. 5, 2024

(30) Foreign Application Priority Data
May 12, 2022 (JP) 2022-079055

(51) Int. Cl. G01C 21/34; G01C 21/36

(52) U.S. Cl. CPC G01C 21/3423; G01C 21/3415; G01C 21/3492; G01C 21/3679; G01C 21/3694

(57) ABSTRACT

Whether or not a component included in a precedingly used vehicle, the precedingly used vehicle being an autonomous driving vehicle, has deteriorated performance is determined, with respect to the component determined to have deteriorated performance, a maintenance location, the maintenance location being a point at which a facility where maintenance of the component determined to have deteriorated performance can be performed exists is extracted, in accordance with the extracted maintenance location, a travel route from a present location of the precedingly used vehicle to a destination is changed to a travel route from the present location to the maintenance location, and, on the changed travel route, a transportation means change location, the transportation means change location being a point at which a user on board the precedingly used vehicle alights from the precedingly used vehicle and changes a transportation means to another transportation means is set.

### TECHNICAL FIELD

The present invention relates to a vehicle route planning device, a vehicle route planning method, and a vehicle route planning system.

### BACKGROUND ART

In PTL 1, a technology for changing a destination when, depending on an abnormal event having occurred in an autonomous driving vehicle during autonomous driving, it is determined that the destination is required to be changed and, when the destination is changed, arranging a connection vehicle headed for the changed destination is described.

### CITATION LIST

### Patent Literature

PTL1: JP 2020-166756 A

### SUMMARY OF INVENTION

### Technical Problem

In the technology described in PTL 1, efficiency of maintenance that is performed on an autonomous driving vehicle in which an abnormality, such as component performance deterioration, has occurred, after the occurrence of abnormality is not taken into consideration. Thus, there is a possibility that, for example, an autonomous driving vehicle in which an abnormality has occurred and maintenance has not. been performed traveling at a lower speed than another vehicle traveling at a legal speed causes traffic flow to deteriorate.

An object of the present invention is to efficiently perform maintenance on an autonomous driving vehicle including a component having deteriorated performance.

### Solution to Problem

According to one aspect of the present invention, whether or not a component included in a precedingly used vehicle, the precedingly used vehicle being an autonomous driving vehicle, has deteriorated performance is determined, and, with respect to the component determined to have deteriorated performance, a detail of performance deterioration is detected. Further, in accordance with the detected detail, a maintenance location, the maintenance location being a point at which a facility where maintenance of the component determined to have deteriorated performance can be performed exists, is extracted. In addition to the above, in accordance with the extracted maintenance location, a travel route from a present location of the precedingly used vehicle to a destination is changed to a travel route from the present location to the maintenance location. On the changed travel route, a transportation means change location, the transportation means change location being a point at which a user on board the precedingly used vehicle alights from the precedingly used vehicle and changes a transportation means to another transportation means, is set.

### Advantageous Effects of Invention

According to an aspect of the present invention, it is possible to efficiently perform maintenance on an autonomous driving vehicle including a component having deteriorated performance.

### BRIEF DESCRIPTION OF DRAWINGS

FIG. 1 is a schematic configuration diagram of a vehicle route planning system;

FIG. 2A is an explanatory diagram illustrative of a functional configuration of a vehicle;

FIG. 2B is an explanatory diagram illustrative of a functional configuration of a control device;

FIG. 3 is a flowchart illustrative of operation that the vehicle route planning system performs; and

FIG. 4 is a flowchart illustrative of transportation means change processing.

### DESCRIPTION OF EMBODIMENTS

Embodiments of the present invention will be described below with reference to the drawings. In the description of the drawings, the same or similar parts are provided with the same or similar reference signs, and duplicate descriptions thereof will be omitted. The respective drawings are schematic and do not necessarily depict the actual dimensions or precise configurations of practical implementation of the present invention. The following embodiments indicates devices and methods to embody the technical idea of the present invention by way of example, and the technical idea of the present invention is not intended to be limited to the devices and methods indicated in the following embodiments. The technical idea of the present invention can be subjected to a variety of alterations within the technical scope prescribed by the claims described in CLAIMS.

### Configuration

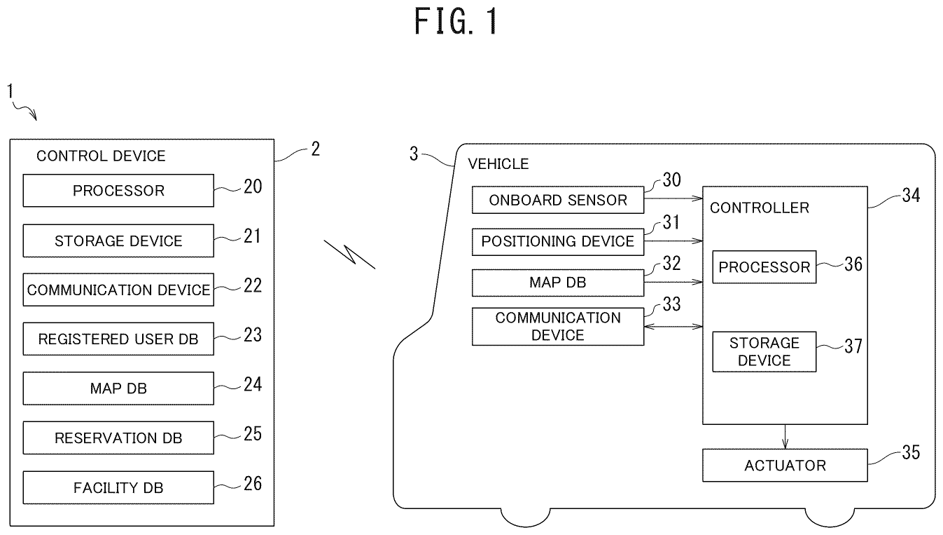

FIG. 1 is a schematic configuration diagram of a vehicle route planning system. A vehicle route planning system 1 is a system that sets a route (travel route) along which a vehicle 3 that is used for movement of a user travels.

The vehicle route planning system 1 includes at least a control device 2 and the vehicle 3 (a service vehicle).

When the user uses the vehicle 3, the user, for example, accesses the control device 2, using an electronic device and reserves the vehicle 3.

The electronic device is a terminal device that the user who makes use of a vehicle dispatch service based on the vehicle route planning system 1 uses. In addition, the electronic device may be, for example, a mobile information terminal that the user can carry or a small-sized computer that is portable, or may be a desktop computer or the like that is installed in a house or the like. Note that in the electronic device, for example, a dedicated application software for using the vehicle route planning system 1 is installed in advance. In the following description, an “application software” is sometimes referred to as “software”. In addition, the user may reserve the vehicle 3 by making use of a browser function of the electronic device and using the Internet.

When the user reserves the vehicle 3, the user generates use request data using the electronic device and transmits the use request data to the control device 2.

The use request data includes, for example, information about the number of persons (including the user himself/herself) who move by making use of the vehicle 3 and information about a boarding place where the user desires to board the vehicle 3 (a desired boarding location) and an alighting place where the user desires to alight from the vehicle 3 (a destination). In addition to the above, the use request data includes, for example, information about a date and time when the user desires to board the vehicle 3 (a desired boarding date and time) and a date and time when the user desires to alight from the vehicle 3 (a desired alighting date and time).

### <Control Device>

The control device 2 (server device) performs processing matching the use request data.

The control device 2 includes a processor 20, a storage device 21, a communication device 22, a registered user database (registered user DB) 23, a map database (map DB) 24, a reservation database (reservation DB) 25, and a facility database (facility DB) 26.

The processor 20 may be, for example, a CPU or an MPU. The storage device 21 may include a non-transitory physical storage medium like registers, a cache memory, and a memory or the like, such as a ROM and a RAM, that is used as a main storage device. Functions of the control device 2, which will be described below, are achieved by, for example, the processor 20 executing computer programs stored in the storage device 21.

The communication device 22 provides a communication function between the control device 2 and an external device. A communication system used by the communication device 22 may be, for example, wired communication or wireless communication via a public mobile communication network, satellite communication, road-to-vehicle communication with the vehicle 3, or the like.

The control device 2 transmits and receives data to and from the vehicle 3 and the electronic device through the communication device 22.

The registered user DB 23 is a database for registering a person who uses the vehicle route planning system 1. In the following description, a person who is registered in the registered user DB 23 is referred to as “registered user”. For example, a user of the vehicle dispatch service is registered in the registered user DB 23 as a person who uses the vehicle route planning system 1.

In the map DB 24, map information of an area in which the vehicle route planning system 1 provides the vehicle dispatch service is stored. The map information may be, for example, map data for navigation (hereinafter, simply referred to as “navigation map”).

The control device 2 calculates, in response to the use request data, a travel route starting from a desired boarding location and reaching a destination included in the use request data, based on the map information stored in the map DB 24. In addition, the control device 2 predicts an alighting date and time at which the vehicle 3 that departed at a desired boarding date and time included in the use request data has traveled along the travel route and arrives at the destination.

The control device 2 stores the desired boarding location, the desired boarding date and time, and the destination included in the use request data and the travel route and the alighting date and time calculated by the control device 2 in the reservation DB 25 as an operation plan of the vehicle 3.

In addition, the control device 2 outputs the operation plan including the desired boarding location, the desired boarding date and time, the destination, the alighting date and time, and the travel route to the vehicle 3.

The facility DB 26 stores a detail of performance deterioration that is detected when a component included in the vehicle 3 has deteriorated performance and a maintenance location that is a point at which a facility where maintenance of a component having deteriorated performance can be performed exists in association with each other.

### <Vehicle>

The vehicle 3 is a vehicle that is operated in response to a request from a user (a vehicle in so-called demand-type transportation) and may be, for example, a shared taxi or a robot taxi.

In addition, the vehicle 3 is an autonomous driving vehicle that is driven by a controller 34 in an automated manner without involvement of a driver (a human) in accordance with an operation plan output from the control device 2.

When the vehicle 3 receives an operation plan from the control device 2, the vehicle 3 travels to a boarding place included in the operation plan in such a way as to arrive at the boarding place before a desired boarding date and time included in the operation plan. In addition, when a user boards the vehicle 3 at the boarding place, the vehicle 3 travels to an alighting place included in the operation plan along a travel route included in the operation plan.

The vehicle 3 includes onboard sensors 30, a positioning device 31, a map database (map DB) 32, a communication device 33, the controller 34, and actuators 35.

The onboard sensors 30 include object sensors configured to detect an object around the vehicle 3 and vehicle sensors configured to detect various information acquired from the vehicle 3 (vehicle state).

The object sensors detect a surrounding environment of the vehicle 3, such as a relative position between the vehicle 3 and an object existing around the vehicle 3, distance between the vehicle 3 and the object, and a direction in which the object exists. The object sensors may include, for example, a camera to capture an image of the surrounding environment of the vehicle 3. In addition, the object sensors may include, for example, a ranging device, such as a laser range finder (LRF), a radar, and a laser radar of a light detection and ranging (LiDAR). The object sensors output surrounding environment information that is information about the detected surrounding environment of the vehicle 3, to the controller 34.

The vehicle sensors may include, for example, a vehicle speed sensor to detect travel speed (vehicle speed) of the vehicle 3, wheel speed sensors to detect rotational speeds of respective tires that the vehicle 3 includes, and a triaxial acceleration sensor (G sensor) to detect acceleration (including deceleration) in three axial directions of the vehicle 3. In addition, the vehicle sensors may include, for example, a steering angle sensor to detect a steering angle (including a turning angle), a gyro sensor to detect angular velocity generated in the vehicle 3, and a yaw rate sensor to detect a yaw rate. Further, the vehicle sensors may include, for example, a seat belt sensor to detect fastening and unfastening of a seat belt and a door sensor to detect opening and closing of a door. The vehicle sensors output vehicle state information to the controller 34.

The positioning device 31 measures a present location and a posture of the vehicle 3. The positioning device 31 may include, for example, a global navigation satellite system (GNSS) receiver. The GNSS receiver may be, for example, a global positioning system (GPS) receiver or the like. The positioning device 31 may include an inertial navigation device. The positioning device 31 outputs present location information about the measured present location to the controller 34.

The map DB 32 stores map information. The map information may include, for example, map data for navigation (hereinafter, simply referred to as “navigation map”) and high-definition map data (hereinafter, simply referred to as “high-definition map”) that is suitable for a map for autonomous driving.

The communication device 33 provides a communication function between the vehicle 3 and an external device. A communication system used by the communication device 33 may be, for example, wireless communication via a public mobile communication network, satellite communication, road-to-vehicle communication, or the like.

The vehicle 3 transmits and receives data to and from the control device 2 through the communication device 33.

The controller 34 is an electronic control unit configured to control the vehicle 3. For example, the controller 34 performs autonomous driving control of the vehicle 3. The controller 34 includes a processor 36 and peripheral components, such as a storage device 37. The processor 36 may be, for example, a CPU or an MPU. The storage device 37 may include a non-transitory physical storage medium like registers, a cache memory, and a memory or the like, such as a ROM and a RAM, that is used as a main storage device. Functions of the controller 34 are achieved by, for example, the processor 36 executing computer programs stored in the storage device 37.

The controller 34 performs autonomous driving control to cause the vehicle 3 to travel in accordance with an operation plan, based on the surrounding environment information and the vehicle state information from the onboard sensors 30, a positioning result of the positioning device 31, and the map information in the map DB 32. For example, the controller 34 calculates a target travel trajectory along which the vehicle 3 is caused to travel, based on the present location and the posture of the vehicle 3, a travel route included in the operation plan, the map information, and the surrounding environment of the vehicle 3. In addition, the controller 34 generates, for example, a route space map that represents routes and existence or nonexistence of an object around the vehicle 3 and a risk map that is generated by quantifying a degree of risk during traveling. Further, the controller 34 generates a target travel trajectory, based on motion characteristics of the vehicle 3, the vehicle state information, the route space map, and the risk map. The controller 34 drives the actuators 35 in such a way that the vehicle 3 travels along the generated target travel trajectory.

The actuators 35 drives the vehicle 3 in an automated manner by generating vehicle behavior of the vehicle 3 through operating a steering device, a drive device, and a braking device of the vehicle 3 in response to a control signal from the controller 34. The actuators 35 include a steering actuator, an accelerator opening actuator, and a brake control actuator.

Note that in the embodiment, a case where the configuration of the vehicle 3 includes an in-vehicle terminal that includes an information output unit, such as a display screen and a speaker, and an information input unit, such as a touch panel and a button, will be described as an example.

### <Functional Configuration of Vehicle>

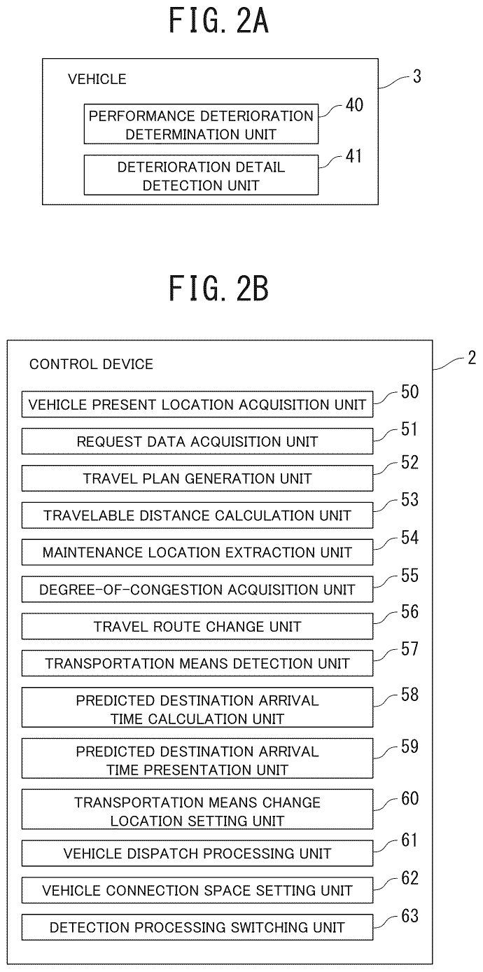

Details of the vehicle route planning system 1 will be described below. FIG. 2A is an explanatory diagram illustrative of (an example of) a functional configuration of the vehicle 3.

The vehicle 3 includes a performance deterioration determination unit 40 and a deterioration detail detection unit 41.

The performance deterioration determination unit 40 determines whether or not a component included in the vehicle 3, such as the onboard sensors 30, has deteriorated performance.

In the embodiment, a case where a component targeted in determination in which the performance deterioration determination unit 40 determines whether or not the component has deteriorated performance is assumed to be one of the onboard sensors 30 configured to detect the surrounding environment of the vehicle 3 will be described as an example.

In addition, the performance deterioration determination unit 40 determines that the camera included in the onboard sensors 30 has deteriorated performance when, for example, although a sign, such as signs indicating a temporary stop position, an intersection, and a right or left-turn road, exists at a position that can be captured using the camera, the sign cannot be recognized from a captured image by the camera.

The deterioration detail detection unit 41 detects, with respect to the component that is determined to have deteriorated performance by the performance deterioration determination unit 40, a detail of the performance deterioration.

When the deterioration detail detection unit 41 detects a detail of performance deterioration of the camera included in the onboard sensors 30, the deterioration detail detection unit 41 detects the detail of performance deterioration to be “intermediate” when, for example, in the case where normal performance of the camera is set to be “high”, the performance of the camera has deteriorated to approximately 50 percent of the normal performance. Further, the deterioration detail detection unit 41 detects the detail of performance deterioration to be “low” when the performance of the camera has deteriorated to approximately 30 percent of the normal performance.

In addition, when the detail of performance deterioration cannot be detected with respect to a component determined to have deteriorated performance, the deterioration detail detection unit 41 outputs a signal including information indicating that the detail of performance deterioration cannot be detected, to the control device 2.

### <Functional Configuration of Control Device>

FIG. 2B is an explanatory diagram illustrative of (an example of) a functional configuration of the control device 2.

The control device 2 includes a vehicle present location acquisition unit 50, a request data acquisition unit 51, a travel plan generation unit 52, a travelable distance calculation unit 53, a maintenance location extraction unit 54, a degree-of-congestion acquisition unit 55, and a travel route change unit 56. In addition to the above, the control device 2 includes a transportation means detection unit 57, a predicted destination arrival time calculation unit 58, a predicted destination arrival time presentation unit 59, a transportation means change location setting unit 60, a vehicle dispatch processing unit 61, a vehicle connection space setting unit 62, and a detection processing switching unit 63.

The vehicle present location acquisition unit 50 acquires a present location of the vehicle 3, using present location information that the positioning device 31 outputs.

When the request data acquisition unit 51 receives use request data from the electronic device, the request data acquisition unit 51 registers information that the use request data includes, in the reservation DB 25.

The travel plan generation unit 52 generates an operation plan according to the information that the request data acquisition unit 51 registered in the reservation DB 25.

When the travel plan generation unit 52 generates an operation plan, the travel plan generation unit 52 sets a travel route starting from the present location and reaching the destination, based on the information included in the use request data and the map information stored in the map DB 24.

In addition, the travel plan generation unit 52 stores the calculated travel route in the reservation DB 25. Through this operation, the travel route that the travel plan generation unit 52 has set is stored in the reservation DB 25 as an operation plan of the vehicle dispatch service provided to the user.

Further, the travel plan generation unit 52 outputs operation plan information about the operation plan to the vehicle 3 provided for use by the user and the electronic device.

The travelable distance calculation unit 53 calculates a distance travelable by the vehicle 3 including a component determined to have deteriorated performance by the performance deterioration determination unit 40.

Specifically, first, the travelable distance calculation unit 53 calculates a travel speed that the vehicle 3 can output, according to a detail that the deterioration detail detection unit 41 detected. When the travelable distance calculation unit 53 calculates a travel speed that the vehicle 3 can output, the travelable distance calculation unit 53 calculates, in the case where the detail of performance deterioration is determined to be “intermediate”, a speed obtained by multiplying a travel speed that the vehicle 3 can output when the performance is “high” (normal travel speed) by “0.9” as a coefficient, as a travel speed that the vehicle 3 can output. In addition, the travelable distance calculation unit 53 calculates, in the case where the detail of performance deterioration is determined to be “low”, a speed obtained by multiplying the travel speed that the vehicle 3 can output when the performance is “high” by “0.75” as a coefficient, as a travel speed that the vehicle 3 can output.

After the travelable distance calculation unit 53 calculates a travel speed that the vehicle 3 can output, the travelable distance calculation unit 53 calculates a distance travelable by the vehicle 3, according to the present location of the vehicle 3 that the vehicle present location acquisition unit 50 acquired and the operation plan (including a travel route and a legal speed) that the travel plan generation unit 52 generated.

The maintenance location extraction unit 54 extracts a maintenance location according to the detail of performance deterioration that the deterioration detail detection unit 41 detected with respect to a component having deteriorated performance.

In addition, the maintenance location extraction unit 54 extracts a maintenance location with reference to the facility DB 26, which stores a detail of performance deterioration that the deterioration detail detection unit 41 detected and a maintenance location in association with each other.

Examples of association between a detected detail of performance deterioration and a maintenance location include combinations described below.

When a component having deteriorated performance is the camera and the detail of performance deterioration is adherence of dirt on a lens, a gas station is associated with the detail of performance deterioration as a maintenance location where maintenance to remove dirt adhering to the lens can be performed.

When a component having deteriorated performance is the camera and the detail of performance deterioration is a malfunction requiring replacement of the component, a vehicle dealer that deals with the vehicle 3 is associated with the detail of performance deterioration as a maintenance location where maintenance to replace a component can be performed.

In addition, the maintenance location extraction unit 54 extracts a maintenance location within a range travelable by the vehicle 3, according to the travelable distance by the vehicle 3, which is calculated by the travelable distance calculation unit 53.

When the maintenance location extraction unit 54 extracts a plurality of the maintenance locations, the degree-of-congestion acquisition unit 55 acquires a degree of congestion of a facility where the maintenance can be performed and that exists at each of the plurality of extracted maintenance locations. Note that the degree of congestion of a facility where the maintenance can be performed is, for example, acquired according to a reservation status or the like of the facility, by using the Internet and the like.

The travel route change unit 56 changes, in accordance with the maintenance location extracted by the maintenance location extraction unit 54, a travel route from the present location of the vehicle 3 to the destination to a travel route from the present location of the vehicle 3 to the maintenance location extracted by the maintenance location extraction unit 54.

In addition, when the maintenance location extraction unit 54 extracts a plurality of maintenance locations, the travel route change unit 56 sets a maintenance location at which a facility having the lowest degree of congestion, which is acquired by the degree-of-congestion acquisition unit 55, exists as a maintenance location of a travel route to which the present travel route is to be changed.

The transportation means detection unit 57 detects another transportation means to which the user can change from the vehicle 3 after alighting from the vehicle 3, the user being on board the vehicle 3 serving as a transportation means, at a point within a section from the present location of the vehicle 3 to the maintenance location on a travel route to which the travel route change unit 56 changed the original travel route.

When the transportation means detection unit 57 detects another transportation means, the transportation means detection unit 57 detects, for example, a boarding and alighting point of a public transportation, a parking lot for bicycles used as a rental bicycle, or the like that exists on the travel route from the present location of the vehicle 3 to the maintenance location, based on the map information stored in the map DB 24. Note that the boarding and alighting point of a public transportation is, for example, a bus stop of a route bus, a train station, or the like.

In addition, when the transportation means detection unit 57 detects another transportation means, the transportation means detection unit 57 detects, for example, a point at which a user can board a connection vehicle on the travel route from the present location of the vehicle 3 to the maintenance location. The connection vehicle is a manual driving vehicle (a taxi or a hired car) or another autonomous driving vehicle.

The predicted destination arrival time calculation unit 58 calculates a continuous travel predicted arrival time that is a time at which a user who is on board the vehicle 3, that is, the vehicle 3 including a component determined to have deteriorated performance, is predicted to arrive at the destination. The calculation of the continuous travel predicted arrival time is performed using, for example, the travel speed that the vehicle 3 can output, the present location of the vehicle 3, the destination of the user, and the map information stored in the map DB 24.

In addition to the above, the predicted destination arrival time calculation unit 58 calculates a changed predicted arrival time that is a time at which the user is predicted to arrive at the destination when another transportation means detected by the transportation means detection unit 57 is used. The calculation of the changed predicted arrival time is performed using, for example, a travel speed that the another transportation means can output, a position at which the user changes the transportation means from the vehicle 3 to the another transportation means, the destination of the user, and the map information stored in the map DB 24. In addition, the calculation of the changed predicted arrival time is performed using, for example, a timetable of a public transportation, distance from the position at which the user changes the transportation means from the vehicle 3 to the another transportation means to a boarding and alighting point of the public transportation, and distance from the boarding and alighting point of the public transportation to the destination of the user.

When the transportation means detection unit 57 detects a plurality of transportation means, the predicted destination arrival time presentation unit 59 presents, to the user, a time at which the user is predicted to arrive at the destination with respect to each of the plurality of transportation means detected by the transportation means detection unit 57.

Specifically, the predicted destination arrival time presentation unit 59 generates an information signal to display, on the display screen of the in-vehicle terminal included in the vehicle 3, the continuous travel predicted arrival time and the changed predicted arrival time calculated by the predicted destination arrival time calculation unit 58 in conjunction with corresponding transportation means, and outputs the generated information signal to the vehicle 3.

In addition, for example, the predicted destination arrival time presentation unit 59 generates an information signal to display, on the display screen of the electronic device carried by the user, the continuous travel predicted arrival time and the changed predicted arrival time calculated by the predicted destination arrival time calculation unit 58 in conjunction with corresponding transportation means, and outputs the generated information signal to the electronic device.

The transportation means change location setting unit 60 sets, on a travel route to which the travel route change unit 56 changed the original travel route, a transportation means change location that is a point at which the user on board the vehicle 3 alights from the vehicle 3 and changes the transportation means to another transportation means, In the embodiment, the transportation means change location is a point at which the user on board the vehicle 3 makes a connection from the vehicle 3 to one of a connection vehicle that is a manual driving vehicle or another autonomous driving vehicle, a public transportation, and a bicycle used as a rental bicycle.

In addition, when the maintenance location extraction unit 54 cannot extract a maintenance location within a range travelable by the vehicle 3 that is calculated by the travelable distance calculation unit 53, the transportation means change location setting unit 60 performs the following processing.

Specifically, the transportation means change location setting unit 60 sets, as a transportation means change location, a road shoulder where the vehicle 3 can stop that exists within a range travelable by the vehicle 3 or a maintenance location that exists within a range travelable by the vehicle 3 and that is stored in the facility DB 26.

Note that the road shoulder where the vehicle 3 can stop that exists within a range travelable by the vehicle 3 is acquired using, for example, the map information stored in the map DB 24. In addition, when the road shoulder where the vehicle 3 can stop is set as the transportation means change location, the control device 2 performs processing of causing the vehicle 3 to stop on the road shoulder. The processing of causing the vehicle 3 to stop on the road shoulder is processing of including, in an operation plan, a travel route for traveling from the present location to a vicinity of the road shoulder and a control signal to control actuators to cause a precedingly used vehicle to move from the vicinity of the road shoulder to the road shoulder and stop on the road shoulder and outputting the operation plan to the vehicle 3.

In addition, when the transportation means detection unit 57 detects a plurality of transportation means, the transportation means change location setting unit 60 sets a transportation means change location that corresponds to, among the plurality of transportation means, a transportation means that is predicted to arrive earliest at the destination of the user. Note that the case where the transportation means detection unit 57 detects a plurality of transportation means is a case where a plurality of transportation means that can be changed at a transportation means change location exist. In addition, the transportation means change location corresponding to a transportation means that is predicted to arrive earliest at the destination is, for example, set using a changed predicted arrival time calculated by the predicted destination arrival time calculation unit 58.

In addition, when, for example, the user who refers to the presented continuous travel predicted arrival time, changed predicted arrival time, and transportation means selects a connection vehicle as a transportation means, the transportation means change location setting unit 60 may set a transportation means change location in consideration of maintenance efficiency of the vehicle 3. This is because when the user selects a connection vehicle as a transportation means, a degree of freedom in setting a transportation means change location is larger than when the user selects a public transportation or a bicycle used as a rental bicycle as a transportation means.

Further, when, for example, the user who refers to the presented continuous travel predicted arrival time, changed predicted arrival time, and transportation means selects a public transportation or a bicycle as a transportation means, the transportation means change location setting unit 60 determines whether or not a plurality of candidates for the transportation means change location exist. When a plurality of candidates for the transportation means change location exist, the transportation means change location setting unit 60 may set a transportation means change location in consideration of maintenance efficiency of the vehicle 3. This is because when the user selects a public transportation or a bicycle used as a rental bicycle as a transportation means, a degree of freedom in setting a transportation means change location is smaller than when the user selects a connection vehicle as a transportation means

When the transportation means change location set by the transportation means change location setting unit 60 is a point at which the transportation means is changed to a connection vehicle, the vehicle dispatch processing unit 61 dispatches a connection vehicle to the transportation means change location set by the transportation means change location setting unit 60.

In addition, the vehicle dispatch processing unit 61, for example, selects and dispatches, as a connection vehicle, a manual driving vehicle or another autonomous driving vehicle that can arrive earliest at the transportation means change location set by the transportation means change location setting unit 60.

When the vehicle connection space setting unit 62 predicts that the vehicle 3 that the user is on board arrives at the transportation means change location behind a connection vehicle, the vehicle connection space setting unit 62 sets the transportation means change location to a space in which a plurality of vehicles can stop. Note that the space in which a plurality of vehicles can stop is, for example, a parking lot or the like that is large enough to allow a plurality of vehicles to be parked. In addition, the processing that the vehicle connection space setting unit 62 performs is executed when the transportation means change location set by the transportation means change location setting unit 60 is a point at which the transportation means is changed to a connection vehicle.

The detection processing switching unit 63 performs processing when deterioration detail detection unit 41 cannot detect, with respect to a component determined to have deteriorated performance by the performance deterioration determination unit 40, a detail of the performance deterioration. Specifically, the detection processing switching unit 63 causes an external control facility to perform processing of detecting a detail of performance deterioration that is originally to be performed by the computer (the vehicle route planning system 1 or the vehicle route planning device).

Note that the control facility is, for example, a maintenance shop set up in a vehicle dealer, a facility that can communicate with an operator belonging to a production company of the vehicle 3, or a vehicle maintenance shop that the vehicle 3 including a component determined to have deteriorated performance can reach by traveling by itself.

### Operation

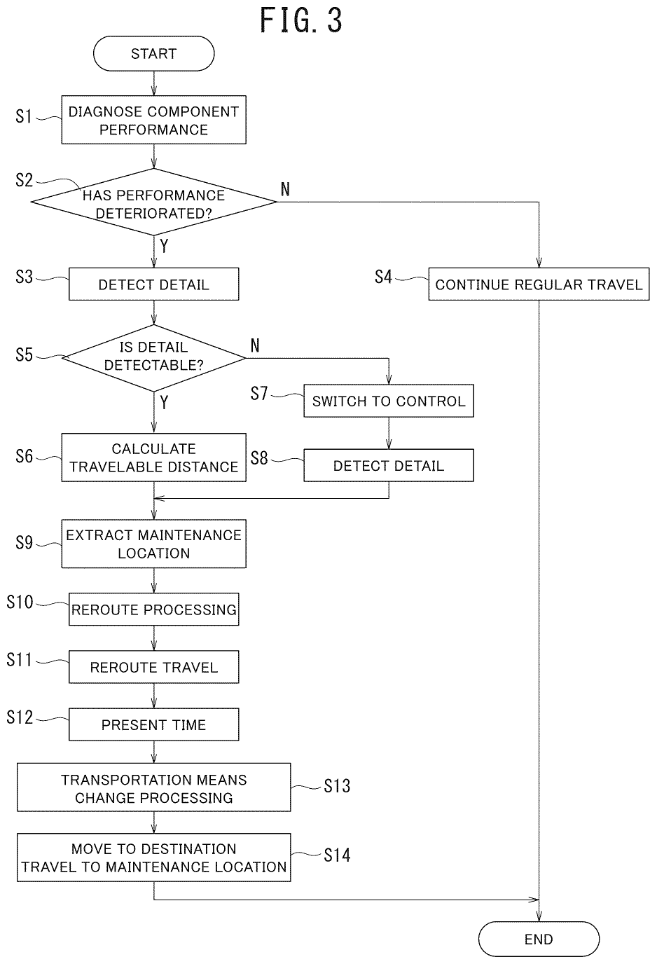

FIG. 3 is a flowchart illustrative of operation that the vehicle route planning system 1 performs.

Note that in the following description, the vehicle 3 that the user has been on board before the transportation means is changed at a transportation means change location is sometimes referred to as “precedingly used vehicle”. In addition, note that the flowchart illustrated in FIG. 3 starts from a state in which the travel plan generation unit 52 has output operation plan information to the precedingly used vehicle and the electronic device and the precedingly used vehicle that the user is on board is traveling.

In step S1, the performance deterioration determination unit 40 diagnoses performance of a component (an onboard sensor 30) included in the precedingly used vehicle. That is, in step S1, the precedingly used vehicle self-diagnoses a state of the onboard sensor 30.

In step S2, the performance deterioration determination unit 40 determines whether or not performance of the onboard sensor 30 has deteriorated from a normal performance. When the performance deterioration determination unit 40 determines that the performance of the onboard sensor 30 has deteriorated (step S2: Y), the process proceeds to step S3. When the performance deterioration determination unit 40 determines that the performance of the onboard sensor 30 has not deteriorated (step S2: N), the process proceeds to step S4.

In step S3, the deterioration detail detection unit 41 detects, with respect to a component that is determined to have deteriorated performance in step S2, a detail of performance deterioration.

In step S4, the precedingly used vehicle continues regular travel and travels toward a destination of the user.

In step S5, the deterioration detail detection unit 41 determines, with respect to the component determined to have deteriorated performance in step S2, whether or not a detail of performance deterioration can be detected. When the deterioration detail detection unit 41 determines that a detail of performance deterioration can be detected (step S5; Y), the process proceeds to step S6. When the deterioration detail detection unit 41 determines that a detail of performance deterioration cannot be detected (step S5: N), the process proceeds to step S7.

In step S6, the travelable distance calculation unit 53 calculates a distance travelable by the precedingly used vehicle including the component having deteriorated performance.

In step S7, the detection processing switching unit 63 causes a control facility to perform processing of detecting, with respect to the component determined to have deteriorated performance in step S1, a detail of the performance deterioration.

In step S8, the control facility detects, with respect to the component determined to have deteriorated performance in step S2, a detail of the performance deterioration.

In step S9, the maintenance location extraction unit 54 extracts a maintenance location according to the detail of performance deterioration detected in step S3 or S8.

In step S10, the travel route change unit 56 performs processing (rerouting processing) of changing, in accordance with the maintenance location extracted in step S9, a travel route of the precedingly used vehicle to a travel route to the maintenance location.

In step S11, the precedingly used vehicle travels along the travel route changed in step S10.

In step S12, the predicted destination arrival time presentation unit 59 presents, with respect to each of the plurality of transportation means detected by the transportation means detection unit 57, a time at which the user is predicted to arrive at the destination, to the user.

In step S13, the transportation means change location setting unit 60 performs processing of setting a transportation means change location on the travel route changed in step S10 (transportation means change processing). Note that the transportation means change processing will be described later.

In step S14, the user moves to the destination, using the precedingly used vehicle or another transportation means, in accordance with the transportation means change location set in step S13. Note that when the user moves to the destination, using another transportation means, the precedingly used vehicle moves to a maintenance location.

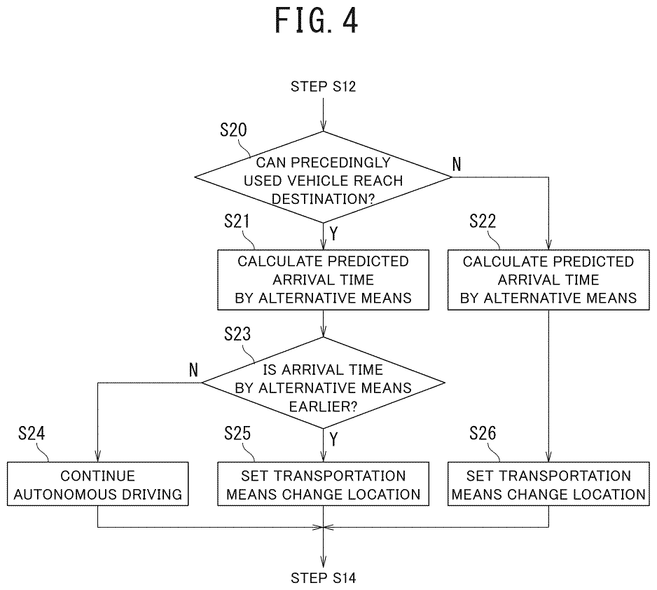

FIG. 4 is a flowchart illustrative of the transportation means change processing.

In step S20, the transportation means change location setting unit 60 determines whether or not the precedingly used vehicle can reach the destination, according to the distance travelable by the precedingly used vehicle, which is calculated in step S6. When the transportation means change location setting unit 60 determines that the precedingly used vehicle can reach the destination (step S20: Y), the process proceeds to step S21. When the transportation means change location setting unit 60 determines that the precedingly used vehicle cannot reach the destination (step S20: N), the process proceeds to step S22.

In step S21, the predicted destination arrival time calculation unit 58 calculates a changed predicted arrival time.

In step S22, the predicted destination arrival time calculation unit 58 calculates a changed predicted arrival time.

In step S23, the transportation means change location setting unit 60 compares the continuous travel predicted arrival time calculated by the predicted destination arrival time calculation unit 58 with the changed predicted arrival time calculated in step S21. The transportation means change location setting unit 60 determines whether or not the changed predicted arrival time is a time earlier than the continuous travel predicted arrival time. That is, in step S23, the transportation means change location setting unit 60 determines whether or not an alternative means of the precedingly used vehicle arrives at the destination earlier than the precedingly used vehicle.

When the transportation means change location setting unit 60 determines that the changed predicted arrival time is a time earlier than the continuous travel predicted arrival time (step S23: Y), the process proceeds to step S25. When the transportation means change location setting unit 60 determines that the changed predicted arrival time is a time later than the continuous travel predicted arrival time (step S23: N), the process proceeds to step S24.

Note that when the transportation means change location setting unit 60 determines that the changed predicted arrival time is the same time as the continuous travel predicted arrival time, the process may proceed to either step S24 or S25.

In step S24, the precedingly used vehicle continues regular travel and travels toward the destination of the user. Note that the processing in step S24 is, for example, performed after approval by the user is acquired.

In step S25, the transportation means change location setting unit 60 sets a transportation means change location that is a point at which the user alights from the precedingly used vehicle and changes the transportation means to another transportation means, depending on the predicted destination arrival time calculation unit 58 calculated in step S21.

In step S26, the transportation means change location setting unit 60 sets a transportation means change location that is a point at which the user alights from the precedingly used vehicle and changes the transportation means to another transportation means, depending on the predicted destination arrival time calculation unit 58 calculated in step S22.

As described in the foregoing, in the present invention, when no component has deteriorated performance, the precedingly used vehicle continues regular travel (travel by autonomous driving) and travels along a travel route included in an operation plan. On the other hand, when a component has deteriorated performance, processing of continuing travel by the precedingly used vehicle, processing of changing a transportation means from the precedingly used vehicle to a connection vehicle or a public transportation, or the like is performed.

### Advantageous Effects of Embodiment

(1) A computer included in a vehicle route planning device constituting a vehicle route planning system 1 performs processing of determining whether or not a component included in a precedingly used vehicle, the precedingly used vehicle being an autonomous driving vehicle, has deteriorated performance. In addition to the above, the computer performs processing of detecting, with respect to the component determined to have deteriorated performance, a detail of performance deterioration and processing of extracting, in accordance with the detected detail, a maintenance location, the maintenance location being a point at which a facility where maintenance of the component determined to have deteriorated performance can be performed exists.

Further, the computer performs processing of changing, in accordance with the extracted maintenance location, a travel route from a present location of the precedingly used vehicle to a destination to a travel route from the present location to the maintenance location. The computer performs processing of setting, on the changed travel route, a transportation means change location, the transportation means change location being a point at which a user on board the precedingly used vehicle alights from the precedingly used vehicle and changes a transportation means to another transportation means.

Because of this configuration, when it is necessary to change a transportation means of the user from the precedingly used vehicle to another transportation means, it becomes possible to set a transportation means change location in consideration of maintenance efficiency for the precedingly used vehicle.

Thus, for example, it becomes possible to efficiently perform maintenance for the precedingly used vehicle that includes a component having deteriorated performance and the travel speed of which is reduced. Because of this capability, for example, it becomes possible to reduce a possibility that the precedingly used vehicle that has not been maintained traveling at a speed lower than another vehicle traveling at a legal speed causes traffic flow to deteriorate.

(2) The computer extracts a maintenance location with reference to a database (the facility DB 26) that stores a detected detail of performance deterioration and a maintenance location in association with each other.

Because of this configuration, it becomes possible to improve speed and precision in extracting a maintenance location.

(3) When the computer extracts a plurality of maintenance locations, the computer acquires a degree of congestion of a facility where the maintenance can be performed and that exists at each of the plurality of extracted maintenance locations. The computer sets a maintenance location at which a facility having the lowest acquired degree of congestion exists as a maintenance location of a travel route to be changed.

Because of this configuration, it becomes possible to reduce time required for maintenance for the precedingly used vehicle that includes a component having deteriorated performance.

(4) The computer calculates distance travelable by the precedingly used vehicle including a component determined to have deteriorated performance, and extracts, according to the calculated distance, a maintenance location within a range travelable by the precedingly used vehicle.

Because of this configuration, it becomes possible to perform, for the precedingly used vehicle including a component having deteriorated performance, maintenance of the component having deteriorated performance before the precedingly used vehicle becomes unable to travel by itself.

(5) When the computer cannot extract a maintenance location within a range travelable by the precedingly used vehicle, the computer sets a road shoulder where the precedingly used vehicle can stop existing within a range travelable by the precedingly used vehicle, as a transportation means change location. Alternatively, the computer sets, as a transportation means change location, a facility existing within a range travelable by the precedingly used vehicle, stored by the database, and where the maintenance can be performed.

Because of this configuration, when a road shoulder is set as a transportation means change location, it becomes possible to cause the precedingly used vehicle including a component having deteriorated performance to stop at a location that has a small influence on traffic flow, before the precedingly used vehicle becomes unable to travel by itself and causes traffic flow to deteriorate. In addition, when a facility where maintenance can be performed is set as a transportation means change location, it becomes possible to perform, for the precedingly used vehicle including a component having deteriorated performance, maintenance of the component having deteriorated performance before the precedingly used vehicle becomes unable to travel by itself.

(6) A transportation means change location is a point at which the user on board the precedingly used vehicle makes a connection from the precedingly used vehicle to one of a connection vehicle, the connection vehicle being a manual driving vehicle or another autonomous driving vehicle, a public transportation, and a bicycle used as a rental bicycle.

Because of this configuration, it becomes possible for the user who is on board the precedingly used vehicle to move to the destination in a shorter period of time than in the case of movement by walking from the precedingly used vehicle that includes a component having deteriorated performance.

(7) When a plurality of transportation means changeable at a transportation means change location exist, the computer sets a transportation means change location corresponding to, among the plurality of transportation means, a transportation means that is predicted to arrive earliest at the destination.

Because of this configuration, it becomes possible to reduce time required for the user who is on board the precedingly used vehicle to arrive at the destination after alighting from the precedingly used vehicle including a component having deteriorated performance.

(8) When a plurality of transportation means with which the user can make a connection at a transportation means change location exist, the computer presents, to the user, a time at which each of the plurality of transportation means is predicted to arrive at the destination.

Because of this configuration, it becomes possible to present, to the user who is on board the precedingly used vehicle, alternatives of the transportation means in consideration of a time at which the alternative is predicted to arrive at the destination.

(9) When the computer predicts that the precedingly used vehicle arrives at the transportation means change location behind a connection vehicle, the computer sets the transportation means change location to a space in which a plurality of vehicles can stop.

Because of this configuration, it becomes possible to reduce a possibility that a connection vehicle that stands by at the transportation means change location until arrival of the precedingly used vehicle deteriorates traffic flow.

(10) When the computer cannot detect a detail of performance deterioration, the computer causes an external control facility to perform processing of detecting the detail of performance deterioration.

Because of this configuration, even when processing performed by the computer cannot detect a detail of performance deterioration, it becomes possible to detect a detail of performance deterioration with respect to a component included in the precedingly used vehicle.

(11) A component targeted in determination of whether or not the component has deteriorated performance is a sensor (onboard sensor 30) configured to detect a surrounding environment of the precedingly used vehicle.

Because of this configuration, it becomes possible to efficiently perform maintenance of the onboard sensor 30 in accordance with a detail of performance deterioration in which performance of the onboard sensor 30, which is an important element in traveling of the autonomous driving vehicle, in detecting a surrounding environment has deteriorated.

(12) In a vehicle route planning method, whether or not a component included in a precedingly used vehicle, the precedingly used vehicle being an autonomous driving vehicle, has deteriorated performance is determined, a detail of performance deterioration is detected with respect to the component determined to have deteriorated performance, and the detected detail is transmitted to a control device 2. The control device 2 extracts, in accordance with the detected detail, a maintenance location, the maintenance location being a point at which a facility where maintenance of the component determined to have deteriorated performance can be performed exists. Further, the control device 2 changes, in accordance with the extracted maintenance location, a travel route from a present location of the precedingly used vehicle to a destination to a travel route from the present location to the maintenance location. In addition to the above, the control device 2 sets, on the changed travel route, a transportation means change location, the transportation means change location being a point at which a user on board the precedingly used vehicle alights from the precedingly used vehicle and changes a transportation means to another transportation means.

Because of this configuration, when it is necessary to change a transportation means of the user from the precedingly used vehicle to another transportation means, it becomes possible to set a transportation means change location in consideration of maintenance efficiency for the precedingly used vehicle.

Thus, for example, it becomes possible to efficiently perform maintenance for the precedingly used vehicle that includes a component having deteriorated performance and the travel speed of which is reduced. Because of this capability, for example, it becomes possible to reduce a possibility that the precedingly used vehicle that has not been maintained traveling at a speed lower than another vehicle traveling at a legal speed causes traffic flow to deteriorate.

(13) A vehicle route planning system 1 configured to determine whether or not a component included in a precedingly used vehicle, the precedingly used vehicle being an autonomous driving vehicle, has deteriorated performance, detect a detail of performance deterioration with respect to the component determined to have deteriorated performance, and includes a control device 2 receiving the detected detail. Further, the control device 2 extracts, in accordance with the received detail, a maintenance location, the maintenance location being a point at which a facility where maintenance of the component determined to have deteriorated performance can be performed exists. The control device 2 changes, in accordance with the extracted maintenance location, a travel route from a present location of the precedingly used vehicle to a destination to a travel route from the present location to the maintenance location. In addition to the above, the control device 2 sets, on the changed travel route, a transportation means change location, the transportation means change location being a point at which a user on board the precedingly used vehicle alights from the precedingly used vehicle and changes a transportation means to another transportation means.

Because of this configuration, when it is necessary to change a transportation means of the user from the precedingly used vehicle to another transportation means, it becomes possible to set a transportation means change location in consideration of maintenance efficiency for the precedingly used vehicle.

Thus, for example, it becomes possible to efficiently perform maintenance for the precedingly used vehicle that includes a component having deteriorated performance and the travel speed of which is reduced, Because of this capability, for example, it becomes possible to reduce a possibility that the precedingly used vehicle that has not been maintained traveling at a speed lower than another vehicle traveling at a legal speed causes traffic flow to deteriorate.

### Variation of Embodiment

(1) Although in the embodiment, the transportation means change location is defined to be a point at which the user on board the precedingly used vehicle makes a connection from the precedingly used vehicle to one of a connection vehicle that is another autonomous driving vehicle, a public transportation, and a bicycle used as a rental bicycle, the present invention is not limited to the configuration. That is, the transportation means change location may be defined to be a point at which the user who is on board the precedingly used vehicle alights from the precedingly used vehicle and moves to the destination by walking. This processing is performed when, for example, a traffic jam has occurred on a road from the transportation means change location to the destination or when a delay or the like has occurred in a public transportation.

### REFERENCE SIGNS LIST

1 Vehicle route planning system
2 Control device
3 Vehicle
20, 36 Processor
21, 37 Storage device
22, 33 Communication device
23 Registered user database
24, 32 Map database
25 Reservation database
26 Facility database
30 Onboard sensor
31 Positioning device
34 Controller
35 Actuator
40 Performance deterioration determination unit
41 Deterioration detail detection unit
50 Vehicle present location acquisition unit
51 Request data acquisition unit
52 Travel plan generation unit
53 Travelable distance calculation unit
54 Maintenance location extraction unit
55 Degree-of-congestion acquisition unit
56 Travel route change unit
57 Transportation means detection unit
58 Predicted destination arrival time calculation unit
59 Predicted destination arrival time presentation unit
60 Transportation means change location setting unit
61 Vehicle dispatch processing unit
62 Vehicle connection space setting unit
63 Detection processing switching unit

1. A vehicle route planning device comprising a computer configured to perform processing comprising:
determining whether or not a component included in a precedingly used vehicle, the precedingly used vehicle being an autonomous driving vehicle, has deteriorated performance;
detecting, with respect to the component determined to have deteriorated performance, a detail of performance deterioration;
extracting, in accordance with the detected detail, a maintenance location, the maintenance location being a point at which a facility where maintenance of the component determined to have deteriorated performance can be performed exists;
changing, in accordance with the extracted maintenance location, a travel route from a present location of the precedingly used vehicle to a destination to a travel route from the present location to the maintenance location, and
setting, on the changed travel route, a transportation means change location, the transportation means change location being a point at which a user on board the precedingly used vehicle alights from the precedingly used vehicle and changes a transportation means to another transportation means.

2. The vehicle route planning device according to claim 1, wherein the computer performs processing including
extracting the maintenance location with reference to a database, the database storing the detected detail of performance deterioration and the maintenance location in association with each other.

3. The vehicle route planning device according to claim 2, wherein the computer performs processing including:
when having extracted a plurality of the maintenance locations, acquiring a degree of congestion of a facility where the maintenance can be performed, the facility existing at each of the plurality of extracted maintenance locations; and
setting the maintenance location at which the facility having the lowest acquired degree of congestion exists as the maintenance location of the travel route to be changed.

4. The vehicle route planning device according to claim 2, wherein the computer performs processing including:
calculating a distance travelable by the precedingly used vehicle including a component determined to have deteriorated performance; and
extracting, according to the calculated distance, the maintenance location within a range travelable by the precedingly used vehicle.

5. The vehicle route planning device according to claim 4, wherein the computer performs processing including
when it is impossible to extract the maintenance location within a range travelable by the precedingly used vehicle, setting, as the transportation means change location, a road shoulder where the precedingly used vehicle can stop existing within a range travelable by the precedingly used vehicle or a facility existing within a range travelable by the precedingly used vehicle, stored by the database, and where the maintenance can be performed.

6. The vehicle route planning device according to claim 1, wherein the transportation means change location is a point at which a user on board the precedingly used vehicle makes a connection from the precedingly used vehicle to one of a connection vehicle, the connection vehicle being a manual driving vehicle or another autonomous driving vehicle, a public transportation, and a bicycle used as a rental bicycle.

7. The vehicle route planning device according to claim 6, wherein the computer performs processing including
when a plurality of transportation means changeable at the transportation means change location exist, setting a transportation means change location corresponding to, among the plurality of transportation means, a transportation means predicted to arrive earliest at the destination.

8. The vehicle route planning device according to claim 6, wherein the computer performs processing including
when a plurality of transportation means with which the user can make a connection at the transportation means change location exist, presenting, to the user, a time at which each of the plurality of transportation means is predicted to arrive at the destination.

9. The vehicle route planning device according to claim 6, wherein the computer performs processing including
when the precedingly used vehicle is predicted to arrive at the transportation means change location behind the connection vehicle, setting the transportation means change location to a space in which a plurality of vehicles can stop.

10. The vehicle route planning device according to claim 1, wherein when it is impossible to detect the detail of performance deterioration, the computer causes an external control facility to perform processing including detecting the detail of performance deterioration.

11. The vehicle route planning device according to claim 1, wherein a component targeted in determination of whether or not the component has deteriorated performance is a sensor configured to detect a surrounding environment of the precedingly used vehicle.

12. A vehicle route planning method comprising:
determining whether or not a component included in a precedingly used vehicle, the precedingly used vehicle being an autonomous driving vehicle, has deteriorated performance;
detecting, with respect to the component determined to have deteriorated performance, a detail of performance deterioration;
transmitting the detected detail to a control device;
extracting by the control device, in accordance with the detected detail, a maintenance location, the maintenance location being a point at which a facility where maintenance of the component determined to have deteriorated performance can be performed exists;
changing by the control device, in accordance with the extracted maintenance location, a travel route from a present location of the precedingly used vehicle to a destination to a travel route from the present location to the maintenance location; and
setting by the control device, on the changed travel route, a transportation means change location, the transportation means change location being a point at which a user on board the precedingly used vehicle alights from the precedingly used vehicle and changes a transportation means to another transportation means.

13. A vehicle route planning system comprising a control device configured to determine whether or not a component included in a precedingly used vehicle, the precedingly used vehicle being an autonomous driving vehicle, has deteriorated performance and detecting a detail of performance deterioration with respect to the component determined to have deteriorated performance, the vehicle route planning system comprising a control device that receives the detected detail, wherein the control device performs processing including:
extracting, in accordance with the received detail, a maintenance location, the maintenance location being a point at which a facility where maintenance of the component determined to have deteriorated performance can be performed exists;
changing, in accordance with the extracted maintenance location, a travel route from a present location of the precedingly used vehicle to a destination to a travel route from the present location to the maintenance location, and
setting, on the changed travel route, a transportation means change location, the transportation means change location being a point at which a user on board the precedingly used vehicle alights from the precedingly used vehicle and changes a transportation means to another transportation means.
